(19) United States
(12) Patent Application Publication
(10) Pub. No.: US 2017/0132536 A1
(43) Pub. Date: May 11, 2017

(54) SYSTEM-INITIATED ACTIONS ON BEHALF OF USER

(71) Applicant: Hipmunk, Inc., San Francisco, CA (US)

(72) Inventors: Adam Julian Goldstein, San Francisco, CA (US); Alex Quintana, San Francisco, CA (US); Eric Palm, San Francisco, CA (US); Gregory Millam, San Francisco, CA (US); Zohaib Ahmed, San Francisco, CA (US)

(21) Appl. No.: 15/348,859

(22) Filed: Nov. 10, 2016

Related U.S. Application Data
(60) Provisional application No. 62/253,655, filed on Nov. 10, 2015.

(51) Int. Cl. G06Q 10/02; G06F 17/30; H04L 29/08

(52) U.S. Cl. CPC G06Q 10/025; H04L 67/20; G06F 17/30867; G06Q 50/14

(57) ABSTRACT

Example embodiments provide a system and method for automatically initiating actions on behalf of a user. A networked system generates a search query associated with a travel itinerary of a user and causes a search to be performed using the search query, The networked system detects a condition associated with the travel itinerary that triggers automatically holding a travel component on behalf of the user. In response to detecting the condition, the networked system automatically triggers placement of a hold on the travel component. The networked system then generates and transmits, over a network, a notification to a device of the user indicating the automatically held travel component.

### CROSS REFERENCE TO RELATED APPLICATION

The present application claims the priority benefit of U.S. Provisional Patent Application Ser. No. 62/253,655, filed on Nov. 10, 2015 and entitled “Automatic Actions on Behalf of User” which is incorporated herein by reference in its entirety.

### FIELD

The subject matter disclosed herein generally relates to the technical field of special-purpose machines that facilitate performing actions on behalf of a user, including computerized variants of such special-purpose machines and improvements to such variants, and to the technologies by which such special-purpose machines become improved compared to other special-purpose machines that facilitate automatically performing actions on behalf of the user. Specifically, the present disclosure addresses machines and methods to facilitate automatic performance of actions by a system on behalf of the user.

### BACKGROUND

Websites enable users to search for a variety of information including products and services. Additionally, some websites allow a user to purchase or reserve a selected product or service. More specifically, in the travel industry, a number of websites enable a user to search for and make reservations and bookings. In these instances, the user must be proactive in visiting different websites, entering search criteria in order to compare and select different types of options, and maintain a record of current inventory available. These websites may indicate if inventory is low for a particular travel component (e.g., travel option), but will not perform any actions beyond that. Furthermore, once a reservation is made, the user is responsible for managing their own reservations should delays or cancellations occur.

### BRIEF DESCRIPTION OF DRAWINGS

Various ones of the appended drawings merely illustrate example embodiments of the present subject matter and cannot be considered as limiting its scope.

FIG. 1 is a network diagram illustrating a network environment suitable for performing automatic actions on behalf of a user, according to some example embodiments.

FIG. 2 is a block diagram illustrating components of a networked travel system, according to some example embodiments.

FIG. 3 is a block diagram illustrating components of an analysis engine, according to some example embodiments.

FIG. 4 is a block diagram illustrating components of a lookup engine, according to some example embodiments.

FIG. 5 is a flowchart illustrating operations of the networked travel system in performing a method of automatically taking action on behalf of a user based on a threshold or time component, according to some example embodiments.

FIG. 6 is a flowchart illustrating operations of the networked travel system in performing a method for providing a status change notification, according to some example embodiments.

FIG. 7 is a flowchart illustrating operations of the networked travel system in performing a method for automatically taking action on behalf of a user based on a weather condition, according to some example embodiments.

FIG. 8 is a flowchart illustrating operations of the networked travel system in performing a method for automatically taking action on behalf of a user based on a cancellation, according to some example embodiments.

FIG. 9 is a block diagram illustrating components of a machine, according to some example embodiments, able to read instructions from a machine-readable medium and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. In general, well-known instruction instances, protocols, structures, and techniques have not been shown in detail. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Example methods (e.g., algorithms) facilitate automatically performing action on behalf on a user based on a (predetermined) condition occurring. The condition comprises, for example, transgression of an inventory low threshold, a shortened period of time before travel, a condition likely to cause a delay (e.g., weather condition), or a flight cancellation. Example systems (e.g., special-purpose machines) are configured to automatically perform an action on behalf of the user based on the predetermine condition occurring. In particular, example embodiments provide mechanisms and logic that monitor for the condition and in response to detecting the condition occurring, automatically triggers performance of the action on behalf of the user (e.g., without any proactive user interaction). In example embodiments, the system-initiated action comprises triggering placement of a hold on a travel component (e.g., flight, hotel room, rental car).

As a result, one or more of the methodologies described herein facilitate solving the technical problem of monitoring for occurrence of a condition that will trigger an automatic action performed by a networked system on behalf of the user. The methodologies include generating a search query associated with a travel itinerary (e.g., proposed itinerary or booked itinerary) of a user and causing a search to be performed using the search query. The networked system detects a condition associated with the travel itinerary that triggers automatically holding a travel component on behalf of the user. In response to detecting the condition, the networked system automatically (e.g., without any user interaction) triggers placement of a hold on the travel component. In some embodiments, the automatically triggering placement of the hold on the travel component comprises generating and transmitting instructions to a third-party system to hold the travel component on behalf of the user, the instructions causing an update to a database of the third-party system. The networked system then generates and transmits, over a network, a notification to a device of the user indicating the automatically held travel component.

As such, one or more of the methodologies described herein may obviate a need for certain efforts or resources that otherwise would be involved in a user having to navigate to a plurality of service providers and perform numerous searches at each service provider in order to determine different options, and to continue monitoring each of the service providers for a change in status or a condition which may prompt the user to hold or book a travel component. Instead, example embodiments provide a system that monitors for such conditions and proactively, without user interaction, triggers a hold to be placed on a travel component in response to detecting occurrence of a particular condition. That is, the user does not need to perform countless searches or navigate to a plurality of websites, but is retained by of the networked system. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

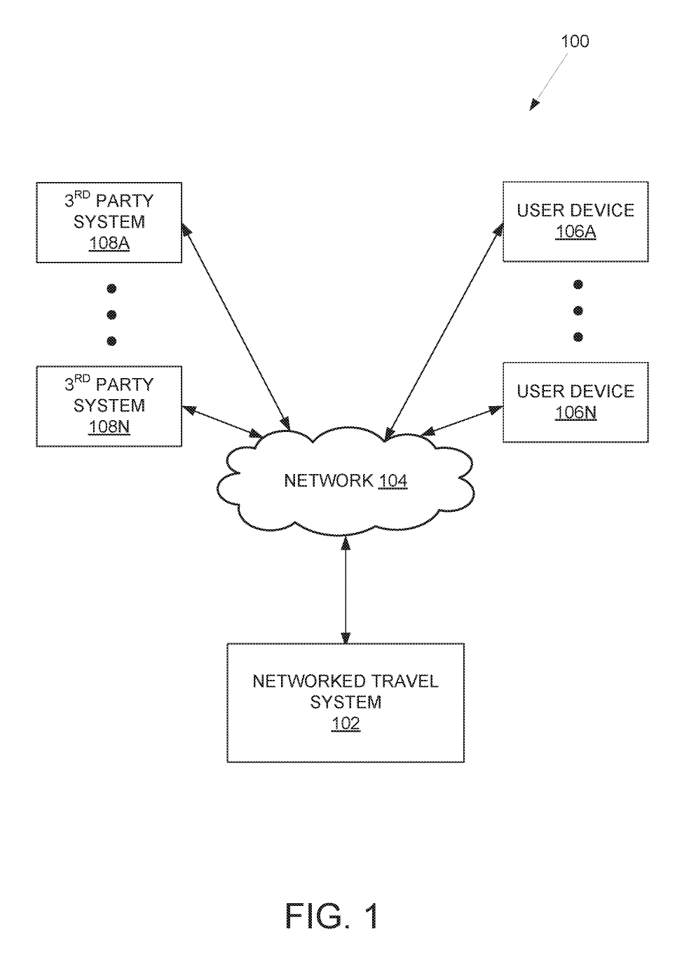

FIG. 1 is a network diagram illustrating a network environment 100 suitable for operating a networked travel system 102 that is configured to automatically perform actions on behalf of a user based on a condition occurring, according to some example embodiments. The network environment 100 includes the networked travel system 102 communicatively coupled via a network 104 to a plurality of user devices 106A-106N. The networked travel system 102 comprises one or more server machines configured to automatically receive and analyze conversations with users (at their respective user device 106), selectively participate in the conversations by providing, when applicable, tailored responses that assist the user in planning and booking a travel itinerary, monitor for conditions that trigger action by the networked travel system, proactively hold (or trigger a hold of) travel components on behalf of the user, and notify the user of the conditions that may affect a travel itinerary and any held travel components.

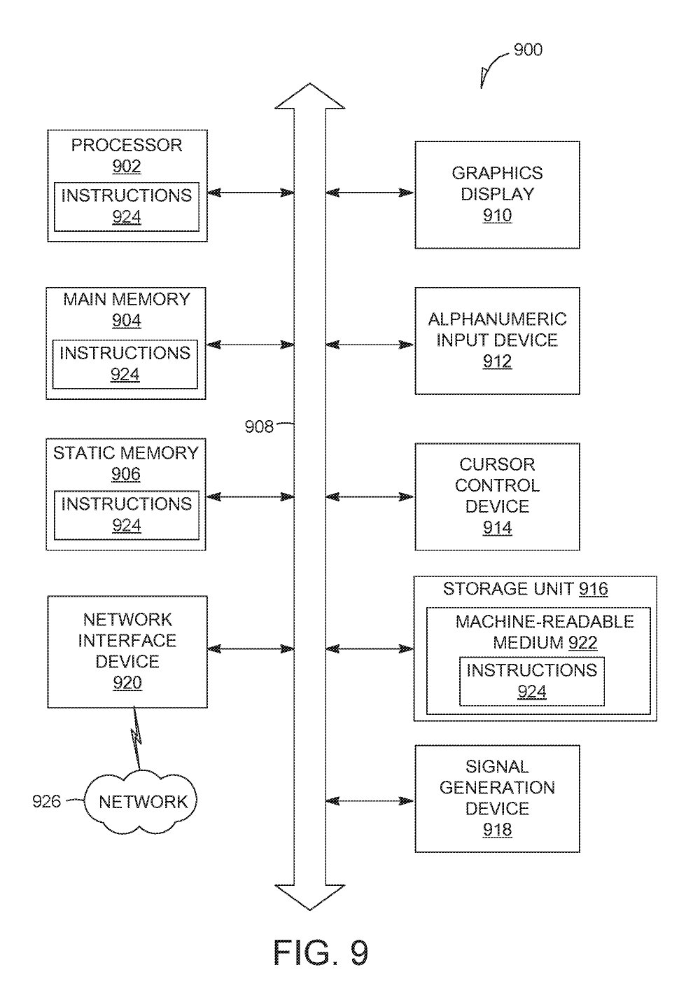

The networked travel system 102 is also coupled, via the network 104, to a plurality of third-party systems 108A-108N. Each of the third-party systems 108 may be, or include, a database that comprises corresponding information or are associated with selectable options (e.g., travel components). For example, a third-party system 108 may be a hotel system that includes a database of hotel room inventory. In another example, the third-party system 108 comprises a weather information system that includes a database of weather data (e.g., current temperature, forecasts, and historical climate for various locations). In some example embodiments, the third-party system 108 comprises a web server machine operated by a third-party (e.g., an entity distinct from an entity that operates the networked travel system 102). The networked travel system 102, the user devices 106A-106N, and the third-party systems 108A-108N may each be implemented in a computer system, in whole or in part, as described below with respect to FIG. 9.

Any of the systems, databases, and devices (each also referred to as a “machine”) shown in FIG. 1 may be implemented in a special-purpose computer that has been modified (e.g., configured or programmed) by software (e.g., one or more software modules) to perform one or more of the functions described herein for that machine. For example, a computer system able to implement any one or more of the methodologies described herein is discussed below with respect to FIG. 9. As used herein, a “database” is a data storage resource and may store data structured as a text file, a table, a spreadsheet, a relational database, a triple store, a key-value store, or any suitable combination thereof. Moreover, any two or more of the systems or devices illustrated in FIG. 1 may be combined into a single machine, and the functions described herein for any single system or device may be subdivided among multiple systems or devices.

The network 104 may be any network that enables communication between or among the systems and devices (e.g., the networked travel system 102 and the user device 106A). Accordingly, the network 104 may be a wired network, a wireless network (e.g., a mobile or cellular network), or any suitable combination thereof. The network 104 may include one or more portions that constitute a private network, a public network (e.g., the Internet), or any suitable combination thereof. Accordingly, the network 104 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 104 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

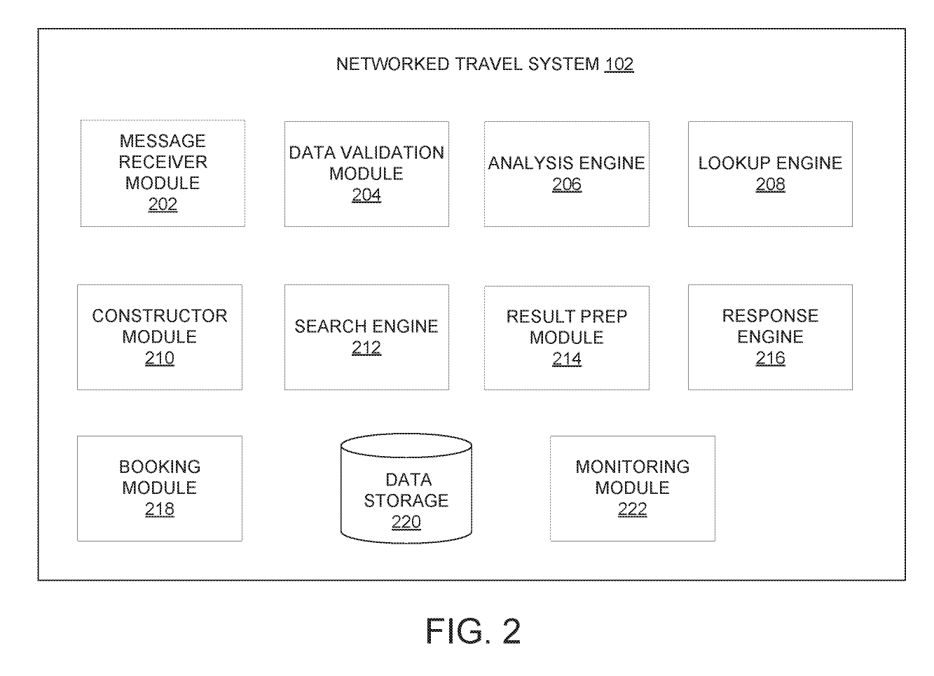

FIG. 2 is a block diagram illustrating components of the networked travel system 102, according to some example embodiments. The networked travel system 102 is configured to work with a user (e.g., customer) through a travel lifecycle and to understand individual and group travel needs by recognizing unique scenarios within conversations in which the networked travel system 102 is also participant (e.g., the user includes the networked travel system 102 as a recipient of the communication). The networked travel system 102 is further configured to facilitate booking of travel components or options (e.g., hotel room, flights(s), rental car, event tickets) and to monitor booked travel components for delays, likely causes of future delays (e.g., storm clouds approaching), and cancellations. In some example embodiments, the networked travel system 102 proactively and automatically (e.g., without user intervention or input) performs actions on behalf of the user (e.g., trigger a hold of a travel component) based on a particular condition occurring. For example, in a situation where a travel component inventory is low (e.g., transgresses a predetermined inventory low threshold), the networked travel system 102 automatically places a hold or reservation on the travel component. Further still, if a flight cancellation is detected or determined to be likely, the networked travel system 102 automatically searches for alternative flights and places a hold on a flight that best matches the canceled flight. The networked travel system 102 may do the same for a delayed flight (e.g., in instances where the anticipated delay will be significant (e.g., over 5 hours)).

As such, the networked travel system 102 receives messages or communications for conversations that the networked travel system 102 is a participant (e.g., the user includes the networked travel system 102 as a recipient of the communication). The communication may comprise an e-mail message, an SMS, a text message, or any other form of communication that is exchangeable between participants. The networked travel system 102 automatically analyzes the communication to determine whether and how to respond in the conversation (e.g., whether to ask a question or provide recommendations, and the specificity of the recommendation). In some embodiments, the response includes a notification of an action automatically performed by the networked travel system 102 (e.g., a hold or reservation automatically made) on behalf of the user. To enable these operations, the networked travel system 102 comprises a message receiver module 202, a data validation module 204, an analysis engine 206, a lookup engine 208, a constructor module 210, a search engine 212, a result preparation module 214, a response engine 216, a booking module 218, at least one data storage 220, and a monitor module 222.

The message receiver module 202 is configured to receive communications (or messages) and queries from the user device 106. For example, a first user at the user device 106A sends an e-mail communication to a second user at the user device 106N. The communication includes the networked travel system 102. as a designated recipient of the communication (e.g., as a primary recipient, as a carbon copy recipient, or as a blind carbon copy recipient. As such, the networked travel system 102 becomes a participant in a conversation between the first and second users. It is noted that any number of users may be involved in a conversation. For example, the conversation can include simply the first user and the networked travel system 102. The communication received by the message receiver module 202 can comprise an e-mail message, a chat message, a text conversation, or any other form of communication between one or more users involving the networked travel system 102.

In one embodiment, the message receiver module 202 identifies the individual users within the conversation and recognizes which communications come from which users in a conversation. As a result, the response engine 216 is able to address users individually and provide customized responses (e.g., a different set of options or recommendations) to each of the users in a group of user that may be traveling together. By identifying which user is providing each communication in the conversation, the networked search system 102 is able to track different needs of individuals (e.g., users may be flying from different airports or traveling on different dates) and to monitor each of their travel itineraries (or proposed travel itineraries) for a condition that will trigger performance of an action by the networked travel system 102 on behalf of the user.

The data validation module 204 is configured to validate the communications received by the message receiver module 202. In some example embodiments, the data validation module 204 checks for spelling errors (e.g., in a name of a location indicated in the communication). The data validation module further determines the date formatting used in the communication (e.g., a month-date-year format versus a date-month-year format).

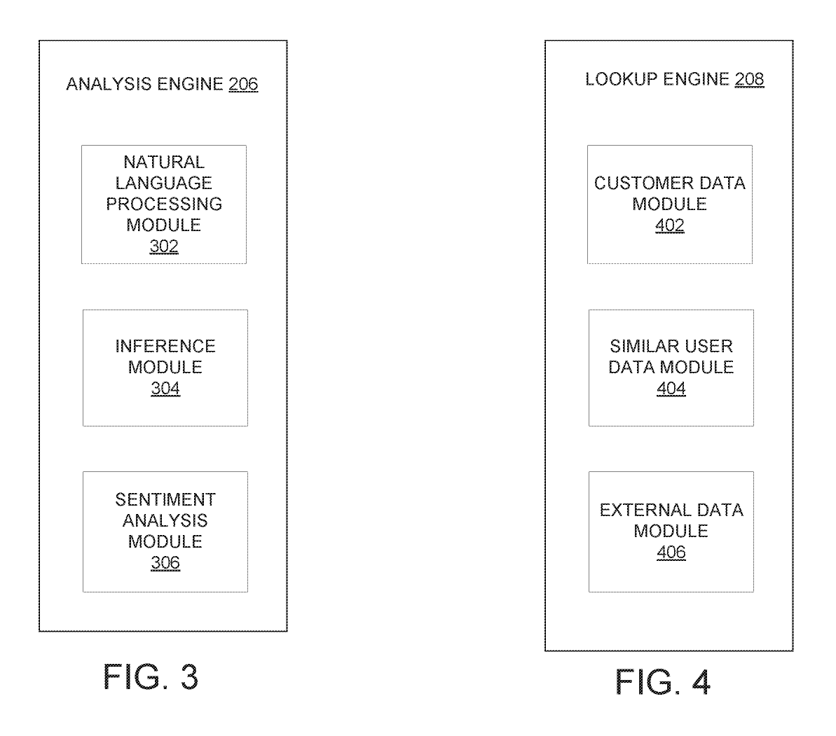

Once the data is validated, the communication is passed to the analysis engine 206, which processes the communication and analyzes data in the communication to identify one or more key terms and a sentiment of each user for use in determining whether to respond and how to respond (e.g., with a question or with options, such as travel components for a travel itinerary) for the one or more users involved in the conversation. In some example embodiments, the analysis engine 206 parses the communication to identify (or extract) the key terms. The key terms may then be associated with the user(s) involved in the conversation and stored to a profile, account, or data structure linked to the user(s) in the data storage 220. The analysis engine 206 also determines the sentiment of the user(s) which indicates whether the networked travel system 102 should respond in the conversation, when to respond in the conversation, and what information to present in the response (e.g., level of detail to respond with). The analysis engine 206 will be discussed in more detail in connection with FIG. 3 below.

The lookup engine 208 is configured to access various data sources to retrieve information that is usable in performing a search for travel components (also referred to as “options”) that make up a travel itinerary. The data sources may include a user profile for each user in the conversation. The user profile may comprise preferences (e.g., airline, car, or hotel preferences), home or origin information (e.g., home airport), past itineraries, and other information that is retrievable by the lookup engine 208 and that may affect the search (e.g., as parameters). The data sources may also include calendar data for the user. In some embodiments, the data sources comprise external (to the networked travel system 102) data sources such as a historical weather source or traffic source. Besides being used in the search process, the retrieved information may also be used to filter, sort, and weigh the search results to generate a customized response tailored to each user. The lookup engine 208 will be discussed in more detail in connection with FIG. 4 below.

The constructor module 210 is configured to construct a search query based in part on data obtained (e.g., extracted, parsed) from the communications in the conversation. As such, the constructor module 210 creates the search query based on user's unstructured text from the conversation. In some example embodiments, the constructor module 210 merges data retrieved by the lookup engine 208 along with key terms detected by the analysis engine 206. In some embodiments, the constructor module 210 also sorts, filters, and weighs one or more of the data retrieved by the lookup engine 208 or the key terms parsed/extracted by the analysis engine 206 in generating the search query.

The search engine 212 receives the search query and performs one or more searches to identify options (e.g., matching travel components). In some example embodiments, the search engine 212 accesses partner databases located at the third-party systems 108 to identify the matching travel components. In these embodiments, the search engine 212 may construct an API request (or the search query generated by the constructor module 210 is the API request) and makes API calls to the third-party systems 108 requesting the matching travel components. For example, the API call triggers a hotel system to identify available hotel rooms in a particular location over a particular time period and determine corresponding room rates. Other third-party systems 108 to which API calls are made may include airline systems (e.g., to search for available flights and fares), car rental systems (e.g., to find rental car availability and rates), and events systems (e.g., find tickets to an event), as well as other systems that search for bundled options available only by reserving multiple types of inventory at the same time (e.g. flights, hotels, and cars) and other systems that provide travel relevant information (e.g., weather conditions, traffic conditions, maps and navigation, flight status).

In some example embodiments, one or more of the search results include an indication of an inventory level. For example, the user may request a particular hotel or (set of) flight(s), or the constructor module 210 constructs a search query that indicates a particular hotel or (set of) flight(s). The search results returned may indicate the inventory remaining for the particular hotel or flight(s).

The search results obtained by the search engine 212 are provided to the result preparation module 214, which prepares the search results for presentation to the user(s). In some example embodiments, the result preparation module 214 tailors the search results based on one or more of user preferences, preferences of similar users, and external data (e.g., weather, traffic) to derive a set of results or options customized to the user(s). For example, if weather for a particular connecting airport is historically bad over a particular time period (e.g., normally expect snow storms) and thus can cause a flight delay, the result preparation module 214 selects an alternative flight route through a connecting airport that historically has better weather. This may be the case even though the flight route through the connecting airport having the historically bad weather is cheaper or has a shorter layover. In further embodiments, the result preparation module 214 uses historical travel information to weigh the results (e.g., based on customer reviews “other families loved this hotel because it had free breakfast.”). As such, the result preparation module 214 weighs various factors (e.g., based on preferences and external data obtained by the lookup engine 208) to rank the search results and to generate the customized set of options for each user. It is noted that each user in the conversation may have a different set of options based, in part, on their preferences and associated key terms (e.g., origin of departure).

Further still, the result preparation module 214 considers inferred goals of the trip by using key terms parsed or identified from the communication to modify recommendations in the set of options to best meet those goals. For example, if the user refers to a sport game or concert in the communication, the result preparation module 214 may recommend hotels close to an arena where the sports game or concert is occurring. In this example, the result preparation module 214 can also match a user's goal to specific hotels based on prior customer reviews. The result preparation module 214 also filters for both positive matches and opposite matches. For example, if the user indicates that they are “looking for a quiet place,” the result preparation module 214 filters out any hotels with keywords of “party,” “night club,” or “loud neighborhood.” These filter terms may be accessed from a library of filter terms that are “learned” by a component (e.g., machine) of the networked travel system 102 through training (which will be discussed further below)

The response engine 216 is configured to determine whether to respond during a conversation with a user or between a plurality of users and what type of response to provide (e.g., based on stage of conversation). Additionally, the response engine 216 generates the response comprising the customized set of options (generated by the result preparation module 214) and transmits, via the network 104, the response to the user(s) involved in the conversation

In some example embodiments, the networked travel system 102 contributes to the conversation as appropriate. Accordingly, the response engine 216 works with the analysis engine 206 to determine which phase in a travel lifecycle the user(s) in the conversation are currently at and a sentiment of the user(s) (as will be discussed further below). Examples of times when the networked travel system 102 proactively enters the conversation include when the user specifically asks the networked travel system 102 a question (e.g., “Can you help us plan a bachelor party?”). In response, the response engine 216 provides a tailored response (e.g., “Yes, I'm happy to help—sounds like fun!”). The response may be obtained from a library of responses maintained in the data storage 220.

Further still, the response engine 216 takes into account actions that indicate that the user wants the networked travel system 102 to pay attention when networked travel system 102 otherwise may not. For example, after forwarding an e-mail to a friend, the user may keep the networked travel system 102 copied (e.g., cc'd) on the email. In this situation, the networked travel system 102 normally will not chime in. However, if the user specifically includes language requesting the networked travel system 102 for help (e.g., “@Hipmunk, help me . . . ” or a similar phrase at the beginning of the e-mail), the networked travel system 102 will interpret this as an indicator that the networked travel system 102 should definitely reply. Thus, if the networked travel system 102 (e.g., the response engine 216) recognizes a question addressed to the networked travel system 102, the response engine 216 will reply.

In one embodiment, the response engine 216 determines whether the communication includes a question to the networked travel system 102 by looking for certain cues that are previously trained to a machine associated with the networked travel system 102 (e.g., a server of the networked travel system 102). For example, the machine is given 800 samples that the networked travel system 102 knows are questions, and “taught” by tagging parts of messages that identify the parts as travel-specific questions. As examples:

“Flight . . .[location 1] . . . [location 2]”

“Place to stay . . . [location]”

“from [location 1] . . . to [location 2]”

Part of the logic in establishing that something meets the above patterns by the networked travel system 102 is “knowing” that something is a “location.” There are rules such as, if it comes directly after the word “from,” then it must he a location—even if the networked travel system 102 has never seen that particular location before. Another example rule is a dash (e.g., “Toronto-Kansas City”). In this example rule, the dash is recognized as dividing an origin and destination. These rules may be stored in the data storage 220 and accessed by various components of the networked travel system 102 during the analysis and search process.

As a general note, there will he instances in which the networked travel system 102 is not “sure enough” it will be able to confidently reply. In these cases, the networked travel system 102 may either give a “best guess” reply (e.g., with a “sorry if this is totally off”-type comment) to the user or forward the question to a human agent (e.g., with an e-mail, text message to an agent's phone), so that a known-sensible reply can be provided. The networked travel system 102 will then learn from this to form future replies in line with previously described learning techniques.

There are other situations when the response engine 216 will provide a reply. For example, if the user gives the networked travel system 102 a command (e.g., “Hipmunk, find me hotels in Las Vegas.”), the response engine 216 will reply (e.g., with hotel options). In another example, the user references the networked travel system 102 (e.g., “Guys, I've cc'd Hipmunk to help us plan our trip to Vegas.”). The response engine 216 then provides an appropriate reply (e.g., “Great! Can you let me know when you'd like to go to Vegas?”). Further still if the user provides information needed to do a travel search (e.g., “Fly from SFO to Vegas October 17-19.”), the response engine 216 provides a reply.

Alternatively, the response engine 216 can determine, in some situations, that a reply is not appropriate. These situations may include if the user does not address the networked travel system 102 in their message, but is only asking questions of friends/other users in the conversation; the conversation is not about travel; it is unclear why the user has added the networked travel system 102 to the conversation; or when the networked travel system 102 determines it should listen to the conversation for an appropriate time to contribute.

The booking module 218 is configured to process booking of travel options or components identified in the customized set of results. In some example embodiments, the user(s) selects a proposed itinerary or various travel components from the customized set of options provided in, or associated with, the response generated and transmitted by the networked system 102, and provides an indication to reserve or pay for those travel options. In response, the booking module 218 processes the reservations or payments (e.g., notifies a travel partner at the corresponding third-party system 109 to reserve the travel component and transmits payment if needed). In one embodiment, a level of assistance by the booking module 218 with the booking is dependent on availability of customer saved payment options. Data associated with the booking (e.g., confirmation number, receipt, booked travel itinerary) are stored to an account or data structure linked to the user(s) in the data storage 220.

In some example embodiments, the booking module 218 proactively and automatically places a hold on a travel component when inventory is detected to be low. As discussed, the search results obtained by the search engine 212. may include an indication of an inventory level for each travel component. If the booking module 218 detects that the inventory level of a particular travel component transgresses a predetermined threshold (e.g., a number of rooms or seats left or a percentage of rooms or sets left), the booking module 218 places a hold on the particular travel component. Additionally or alternatively, the booking module 218 proactively and automatically places a hold on a travel component if the search is for a travel component within a shorten time period (e.g., same day or next day).

The data storage 220 maintains accounts or data structures linked to each user of the networked travel system 102. The data structures include past search history, past travel purchase history, current travel planning information (e.g., key terms identified by the analysis engine 206), user preferences, booked itineraries, and any other user specific information that can be used by the networked travel system 102 to customize search results and responses to the each user. The data storage 202 may comprise one or more databases. As used herein, a “database” is a data storage resource and may store data structured as a text file, a table, a spreadsheet, a relational database (e.g., an object-relational database), a triple store, a hierarchical data store, or any suitable combination thereof.

The monitor module 222 is configured to monitor travel components of interest to the user. in some example embodiments, the travel component of interest is a travel component or option that is recommended by the result preparation module 214 in response to a previously conducted search. In other example embodiments, the travel component of interest is a travel component that is booked for the user.

In the example embodiment where the travel component of interest is a recommendation that has not yet been booked, the monitor module 222 monitors for price changes in the travel component. If a price change is detected or inventory levels fall below a threshold, the monitor module 222 triggers the response engine 216 to transmit a notification to the user (e.g., e-mail, SMS, or text) indicating the price change. The notification may also include information regarding whether the travel component is a “good deal” based on historical pricing.

In example embodiment where the travel component of interest is a booked travel component, the monitor module 222 monitors weather conditions that may affect the travel component or monitors a status of the travel component itself (e.g., on-time status, gate information, baggage claim information, or cancellations). The status information may be proactively provided to the user in a notification transmitted by the response engine 216. In some cases, the status information is provided when there is a change in the status information.

In situations where the monitor module 222 detects a weather condition (e.g., a storm, blizzard, or hurricane) that may affect the travel component, the monitoring module 222 triggers the search engine 212 to find one or more alterative travel options (e.g., flights or hotels). The alternative travel option(s) ideally has characteristics that most closely match the travel component affected by the weather condition (e.g., destination or date/time of arrival). The booking module 219 will then place a hold on the one or more alternative options (e.g., triggering the third-party system 108 to hold the alternative option on behalf of the user), and the response engine 216 transmits a notification to the user indicating the held alternative option(s).

In example embodiments where a flight cancellation is detected by the monitoring module 222, the monitoring module 222 triggers the search engine 212 to find alternative flight options. A “best” flight option (e.g., next available flight, closest in arrival time, same airline) is identified, and the booking module 218 places a hold on the flight option. If the flight cancellation occurs at a location not considered to be an origin of the user (e.g., at a home airport of the user) and the alternative flight options indicate an extended delay (e.g., the “best” flight option is not until the next day), the search engine 212 also searches for a hotel room (e.g., hotel near the airport, hotel with airport shuttle service). The booking module 218 also places a hold on the hotel room. The response engine 216 then transmits a notification to the user indicating the held alternative option(s) (e.g., both the held flight option and the hotel room option).

In some example embodiments, the response engine 216 also informs contacts of the user (e.g., friends, family, business contacts, or any suitable combination thereof) regarding a delay or cancellation. For example, the response engine 216 uses a user's calendar integration to proactively inform anyone impacted by the user's delay/cancellation.

FIG. 3 is a block diagram illustrating components of the analysis engine 206, according to some example embodiments. The analysis engine 206 is configured to parse the communication and analyze communication data to determine key terms and a travel lifecycle of the user(s). In order to perform these operations, the analysis engine 208 comprises a natural language processing module 302, an inference module 304, and a sentiment analysis module 306.

The natural language processing module 302 is configured to use natural language processing algorithms to understand what the user has asked or communicated in a communication, For example, if the user uses an abbreviation for a particular location, the natural language processing module 302 understands the abbreviation represents the particular location. Similarly, if the user misspells a word, the natural language processing module 302 attempts to determine the correct spelling and to interpret the user's request as if the spelling had been correct to begin with. In example embodiments, the natural language processing module 302 parses the communication in order to identify key terms that are provided to the constructor module 210 to generate the search query.

In situations where the user is not explicit in their communication regarding travel plans, the inference module 304 attempts to identify the key terms, For example, the user may either use indirect destination or event definitions (e.g. “my house,” “my birthday”) or not specify the origin at all (e.g. “find me flights to New York”). In these instances, the inference module 304 taps into an existing database of customer knowledge (e.g., profile of the user, data in the data storage 220) to establish what the user likely means. For example, if the user gives a location as “home,” the inference module 304 accesses a user profile of the user to determine where “home” is. In one instance, an IP address of the user can be used to determine a “home” location (e.g., city) of the user. In another example, if the user references an event (e.g., SXSW), the inference module 304 infers (e.g., from stored or accessed data) that SXSW is in Austin. If the user indicates in a subsequent reply that the networked travel system 102 is wrong, then the networked travel system 102 learns for next time. Alternatively, if the networked travel system 102 does not have confidence in an interpretation of what the user means as their destination (or dates, event, etc.), the response engine 216 sends the user a clarifying e-mail, SMS, text, or other form of communication, and subsequently interprets the user's reply as canonical.

For dates, the inference module 304 can use knowledge of common travel behaviors to infer dates even if the dates are not explicitly stated. For example, the inference module 304 knows (e.g., from data in the data storage 220) that most people traveling for Thanksgiving want to travel Wednesday through Sunday from historical booking data. Therefore, if a user asks to travel to “Boston for Thanksgiving,” the inference module 304 infers that the user likely means to travel from Wednesday through Sunday rather than travel on the date of Thanksgiving.

In some embodiments, it is initially ambiguous which dates and destinations go together. For example, the message may recite: “I'm trying to book a trip to Pittsburgh for my cousin's wedding on October 3, and then we're going to tour the Carnegie museum, and stay in a hotel on October 4 to October 7, and then return on October 30.” in these embodiments, the inference module 304 understands that there are multiple dates spread out across the sentence that chronology determines the ordering of trips. A first chronological date in the message is inferred to be an initial departure date, while a last chronological date is inferred to be a final return date. In this example, the inference module 304 also recognizes existence of a “nested” trip, because the middle two dates fall entirely within the initial departure date and the final return date. As a result, the search engine 212 is triggered (e.g., by the inference module 304) to perform multiple searches and combine the results in the reply. The inference module 304 knows that the middle dates correspond to a hotel search because the middle dates are physically proximate (e.g., within the sentence, itself) closer to the word “hotel” than the word “flight” (or, in this case, something that implies a flight). In cases where the user provides a budget, the networked system 102 provides dates or options that match the budget.

Other information may be inferred by the inference module 304. As examples:

“My last trip” references back to a user's prior search or booking history.

“My meeting in Chicago” is meaningful if the user had given access to his calendar.

“Someplace warm” taps into a database of seasonal weather patterns in cities around the world.

Use of plural words (or users) in the conversation infers a group of users.

Past search histories are also taken into account by the inference module 304 to understand what an ambiguous location means. For example, if a user says “Flights to Springfield,” the inference module 304 references against a database of what the most-searched-for “Springfield” is, and return those results, unless the user indicates otherwise.

The sentiment analysis module 306 is configured to determine a sentiment of the user and thus identify a phase in a travel lifecycle that the user is currently at. In some embodiments, the sentiment analysis module 306 infers where the user is within the travel lifecycle based on the language and key terms in the communication a first travel phase (also referred to as an “exploratory phrase”), the user is looking for help with ideas. Some examples of language used include: “looking for ideas,” “romantic beach vacation;” or “Euro trip.” One way that the sentiment analysis module 306 infers the “exploratory-ness” of words (or any other characteristic of words) is using an algorithmic technique known as “word embeddings,” which allows the sentiment analysis module 306 to understand a “distance” between words in a multi-dimensional “meaning” vector-space. For example, “budget” and “cheapest” are both very similar, whereas “cow” and “cheapest” are not.

As an example, take the words “Valentine's Day” in a user's communication. The sentiment analysis module 306 finds the closest “words” associated with “Valentine's Day” in the networked travel system 102′s database of place descriptions (e.g. adjectives that users have used to describe destinations or hotels in the past). This database may include, for example, “romantic,” “loud,” “family-friendly,” and so forth. In this example, the sentiment analysis module 306 determines that “Valentine's Day” is most closely related to “romantic.” The sentiment analysis module 306 next compares the words that match with destinations, themselves. For example, the networked travel system 102 comprises a database that shows “Paris” and “Fiji” ranks highly on a romantic scale, while “Cleveland” does not. With this information, the inference module 304 triggers the constructor module 210 to generate a search query for fares to both Paris and Fiji, and the result preparation module 214 can prioritize the results for the locations that are closest to the user's home in accordance with one embodiment.

In some example embodiments, the networked travel system 102 builds this database of place descriptions by making unique associations between words and destinations. For example, the networked travel system 102 knows that a certain week of the year is Spring Break at New England colleges, and the networked travel system 102 sees a spike in travel searches from cities like Ithaca and State College to Florida beaches. Therefore, the networked travel system 102 makes an entry in the database between “college” and particular destinations in Florida.

A second travel phase (also referred to as the consideration phase) involves the user still trying to decide on their travel plans. In this phrase, the key terms may include, for example “thinking about” and “trying to decide between.” As it relates to understanding how far down a “travel process” the user is, the sentiment analysis module 306 can also take as signals how specific the user's question is. For example, if the user says “I'm looking for flights to New York next week [or in the Spring],” the sentiment analysis module 306 infers that the user is more flexible and perhaps more cost-sensitive. If instead, the user says, “I'm looking for flights to New York next Monday that get in before 5 PM,” the sentiment analysis module 306 infers the user is more schedule-constrained, and therefore more likely to be in a need-to-book mindset. In this example, the reply will, therefore, be more to-the-point and less solicitous of further inputs.

In a third travel phase (also referred to as a purchase phase), a decision has been made by the user to purchase travel components. In this phase, the key terms may include, for example “find me,” “need,” and “get me.”

The sentiment analysis module 306 also looks at the types of questions that are asked in the communication to determine a travel purchase phase of the user. In the exploratory phase, the questions can include, for example, “What's a great beach getaway on a budget?” or “Can you send me some ideas for places to visit in Europe?” In the consideration phase, the questions contain more details (e.g., an indication of a location). For example, the questions can be “What's the cheapest day to fly from DFW to Tokyo in December?” or “Can you help me find a cheap hotel in downtown Portland?” Finally, in the purchase phase, the question will be very specific. Example questions in this phase include “I'm flying from Dallas to Tokyo on December 18, can you send me good flights?” and “I want to book the Sheraton in Portland on January 10.”

The sentiment analysis module 306 also examines conversation among users in a group to determine the travel purchase phase. For example, in the exploratory phase, the conversation can include comments such as, “We're planning a bachelor party!” or “Let's do a ladies weekend,” while in the consideration phase, the comments are “We're looking for great hotels for a bachelor party in Vegas.” or “We're trying to decide if our group should stay in a house or a hotel in Sonoma?” Finally, in the purchase phase, the comments in the conversation include specifics, such as “We want to book a vacation rental for our group in Sonoma on December 12.” or “We've decided we want a hotel for the bachelor party on the Strip in Vegas” (this assumes the networked travel system 102 has previous knowledge, for example, from a prior message, for the dates of the bachelor party).

FIG. 4 is a block diagram illustrating components of the lookup engine 208, according to some example embodiments. The lookup engine 208 is configured to access various information that is used to construct the search criteria and weigh the search results. To enable these operations, the lookup engine 208 comprises a customer data module 402, a similar user data module 404, and an external data module 406.

The customer data module 402 assesses existing user data. In some example embodiments, the existing user data is retrieved (e.g., from an account linked to the user) from the data storage 220. The existing user data provides user preferences either explicitly provided by the user or inferred from past searches and purchases. For example, the user may prefer to only fly certain airlines or stay at particular brands of hotels. The user may also have provided frequent membership information for various travel partners (e.g., frequently flyer membership number). The user data can also integrate service preferences (e.g., Foursquare, Yelp, OpenTable) and historical behavior (e.g., particular restaurants, museums, or locations visited). These preferences can be used by the constructor module 210 to construct the search query, or used by the results preparation module 214 to generate (e.g., filter, weigh) the set of options.

The similar user data module 404 assesses user data of other users that share similar characteristic with the user. For example, the other users may share similar demographics with the user (e.g., age, income, origin of travel). The user data provides preferences or feedback (e.g., reviews) of the other users that share the similar characteristics with the user. These preferences can be used by the constructor module 210 to construct the search query, or used by the results preparation module 214 to generate the set of results (e.g., weight, sort, or filter the set of options).

The external data module 406 accesses external sources (e.g., third-party systems 108) for information that can affect the search query or be used to weigh and filter the search results in generating the set of results by the result preparation module 214. In an example using on-time percentage, a flight is $25 cheaper, but is only on-time 50% of the time. In this example, the result preparation module 214 may advise against this option over a flight with better on-time percentage. in another example, two flight options from SFO to Hartford in February are under consideration. One flight stops in Dallas and the other in Chicago. A weather source can be accessed, by the external data module 406, to determine weather forecasts/predictions for Dallas and Chicago in February. This weather information is used to recommend (by the result preparation module 214) the option via Dallas to avoid snow delays in Chicago. The result preparation module 214 may also provide historical weather information to the user (e.g., Chicago faced 79 snow delays last year).

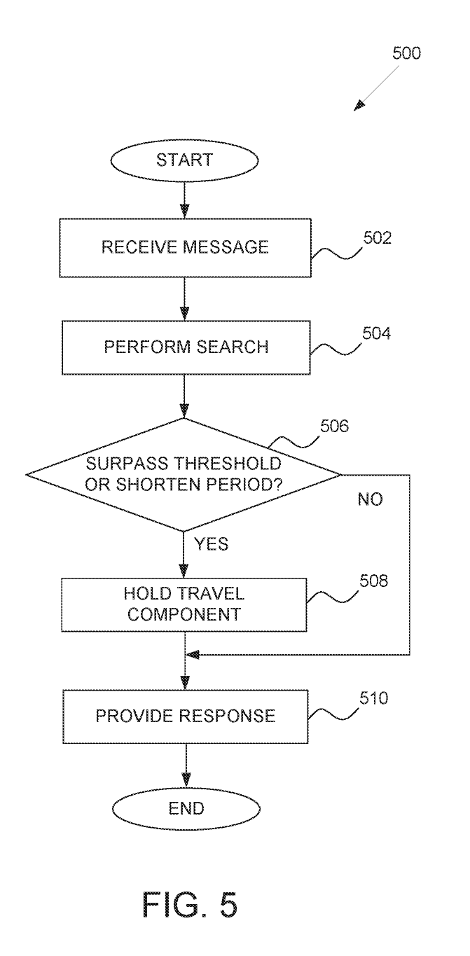

FIG. 5 is a flowchart illustrating operations of the networked travel system 102 in performing a method 500 for automatically taking action on behalf of a user based on a threshold or time component associated with a proposed travel itinerary, according to some example embodiments. Accordingly, the method 500 is described by way of example with reference to the networked travel system 102. However, it shall be appreciated that at least some of the operations of the method 500 may be deployed on various other hardware configurations and the method 500 is not intended to be limited to the networked travel system 102.

In operation 502, the message receiver module 202 receives a communication to which the networked travel system 102 is a participant. For example, the networked travel system 102 may he cc'd on an e-mail communication between one or more users planning a trip or the user may send a direct inquiry to the networked travel system 102. In some example embodiments, the communication may be validated by the data validation module 204 and date formatting identified.

In operation 504, a search is performed. In some example embodiments, the communication is analyzed by the analysis engine 206 to determine key terms. Optionally, user data (e.g., including similar user data from other users) is looked up to identify preferences, and external data that can affect the search query accessed. External data may include, for example, on-time performance, weather conditions, traffic conditions, reviews, or any other information obtainable (e.g., from a third-party source) that can affect the search query and the ranking of search results. Subsequently, the constructor module 210 constructs a search query based on the user's unstructured text from the conversation (e.g., key terms parsed from the communication) along with the user data and any external data. Next, the search engine 212 receives the search query constructed by the construction module 210, and triggers performance of one or more searches to identify matching travel options. In some example embodiments, the search engine 212 accesses (or triggers searches of) partner databases located at the third-party systems 108 to identify the matching travel options. For example, the search engine 212 makes an API call to a hotel system that causes the hotel system to identify available hotel rooms in a particular location over a particular time period and the corresponding rates. Other third-party systems 108 that are searched may include airline systems (e.g., to search for available flights), car rental systems (e.g., to find rental car availability and rates), and events systems (e.g., find tickets to an event).

In operation 506, a determination is made as to whether a travel option (e.g., hotel room or flight) inventory is low of if the search is for a travel option within a shorten time period. With respect to inventory, the booking module 218 detects whether an inventory level of a particular travel option transgresses a predetermined threshold (e.g., a number of rooms or seats left or a percentage of rooms or seats left). If the inventory level transgresses the predetermined threshold (e.g., there are only five seats left, the hotel is 90% full), the booking module 218 automatically, and without user intervention or input, places a hold on the travel option in operation 508 (e.g., place a hold on a seat on the flight or a room at the hotel). Accordingly, the booking module 218 may transmit instructions (e.g., makes an API call) to the third-party system 108 to hold the travel option, which causes the third-party system 108 to update its database to indicate the held travel option.

With respect to the shortened time period, the booking module 218 detects whether the search is for a travel option within a shortened time period (e.g., same day, next day). If the search is for a travel option within a shortened time period, the booking module 218 automatically, and without user intervention or input, places a hold on the travel option in operation 508 (e.g., hold a seat on the flight or a room at the hotel). Accordingly, the booking module 218 may transmit instructions (e.g., makes an API call to the third-party system 108) to hold the travel option, which causes the third-party system 108 to update its database to indicate the held travel option. It is noted that more than one travel option may be held for the user. For example, any combination of a hotel room, flight, car rental, or train ticket may be held on behalf of the user.

The user is notified in operation 510 regarding the held travel option. Accordingly, the response engine 222 generates and transmits a message to the user notifying the user of the held travel option. The user than has the option to accept the held travel option (e.g., confirm the itinerary, pay for the travel option). The held travel option is then converted to a booked or purchased travel option upon the user accepting the travel option. In example embodiments, instructions are generated and transmitted to the third-party system 108 to convert the held travel option to a booked travel option or component.

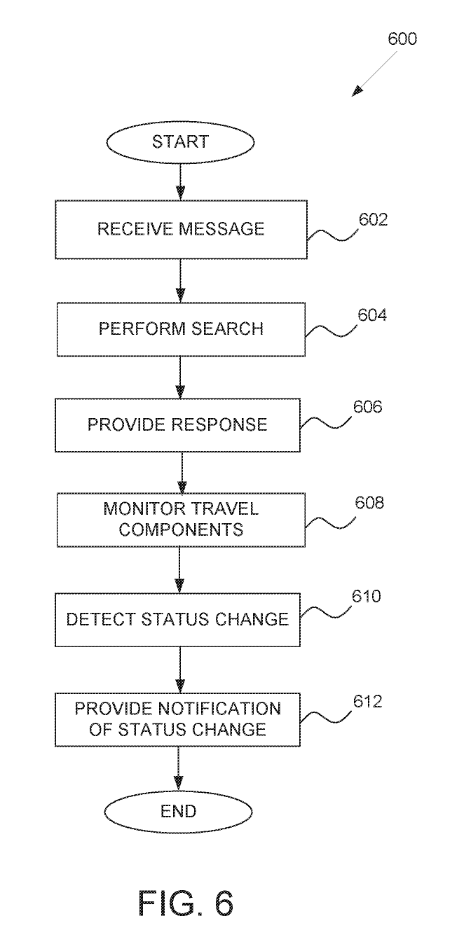

FIG. 6 is a flowchart illustrating operations of the networked travel system 102 in performing a method 600 for providing a status change notification, according to some example embodiments. Accordingly, the method 600 is described by way of example with reference to the networked travel system 102. However, it shall be appreciated that at least some of the operations of the method 600 may be deployed on various other hardware configurations and the method 600 is not intended to be limited to the networked travel system 102.

In operation 602, the message receiver module 202 receives a message to which the networked travel system 102 is a participant (e.g., copied on an e-mail communication with one or more users; sent a direct inquiry). In some example embodiments, the communication may be validated by the data validation module 204 and date formatting identified.

In operation 604, a search is performed. In some example embodiments, the communication is analyzed by the analysis engine 206 to determine key terms, and relevant user data, similar user data, and external data accessed. A search query is constructed by the constructor module 210, and the search engine 212 causes one or more searches to be performed. In some embodiments, the searches are performed on partner databases located at the third-party systems 108 (e.g., via API calls) to identify matching travel options. Tailored results (e.g., best itinerary based on key terms and user preferences) are then provided to the user in operation 606.

The method 600 assumes that the user does not immediately book any travel components based on the search. Accordingly, the networked travel system 102 retains the tailored results in an account associated with the user and monitors the travel components included in the tailored results in operation 608.

In operation 610, the monitoring module 222 detects a status change to one of the travel options. For example, suppose that the price of the travel option has dropped at least a threshold amount. In response, the monitoring module 222 triggers the response engine 216 to transmit a notification to the user (e.g., e-mail message, SMS, text message) indicating the status change in operation 612. in cases where the status change is a price change, the notification may also include information regarding whether the travel option is a “good deal” based on historical pricing (e.g., excessed from an external source). Other examples of status change can include drop in inventory or an addition of a new flight to a route.

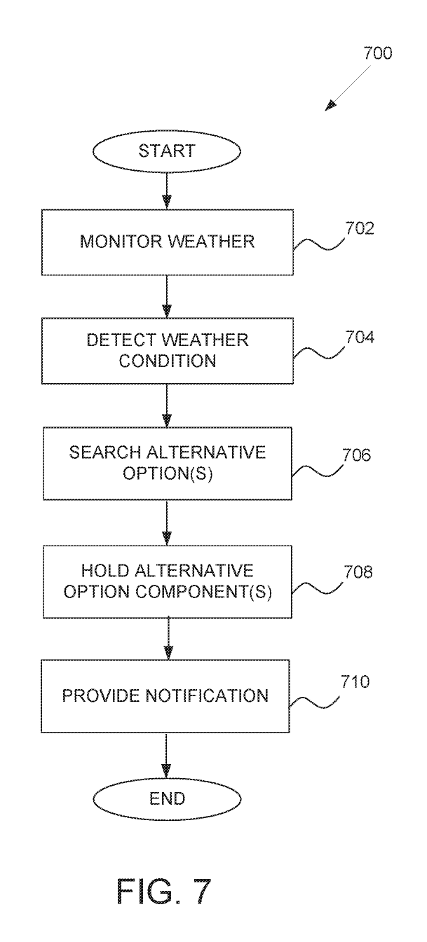

FIG. 7 is a flowchart illustrating operations of the networked travel system 102 in performing a method 700 for automatically taking action on behalf of a user (e.g., without user intervention or input) based on a weather condition, according to some example embodiments. Accordingly, the method 700 is described by way of example with reference to various components of the networked travel system 102. However, it shall be appreciated that at least some of the operations of the method 700 may be deployed on various other hardware configurations and the method 700 in not intended to be limited to the various components of the networked travel system 102.

In operation 702, the monitoring module 222 monitors for weather conditions that may affect one or more travel components of a booked itinerary. For example, the monitoring module 222 may periodically access a third-party weather system (e.g., at a third-party system 108) and determine whether any weather conditions (e.g., a storm, blizzard, hurricane) may affect the booked itinerary.

If a weather condition that will affect the booked travel itinerary is detected in operation 704, the monitoring module 222 triggers the search engine 212 to find one or more alternative options (e.g., flights, hotels, trains, buses) in operation 706. The alternative options ideally have characteristics that most closely match the travel component affected by the weather condition (e.g., destination, date/time of departure or arrival) taking into account any preferences of the user (e.g., preferred hotels or airlines, preferred types of hotels or flight class, least number of connections, lowest costs).

A “best” alternative option (e.g., next available flight, closest in arrival time) is identified, and the booking module places a hold on the alternative option in operation 708. Subsequently in operation 710, the response engine 216 transmits a notification to the user indicating the held alternative option. The user can accept (e.g., confirm the itinerary, pay for the alternative option) the held alternative option (e.g., alternative travel component). The held alternative option that is accepted is converted to a booked or purchased travel component upon the user accepting the option. It is noted that more than one alternative option may be held, and the user can select to accept one of the held options.

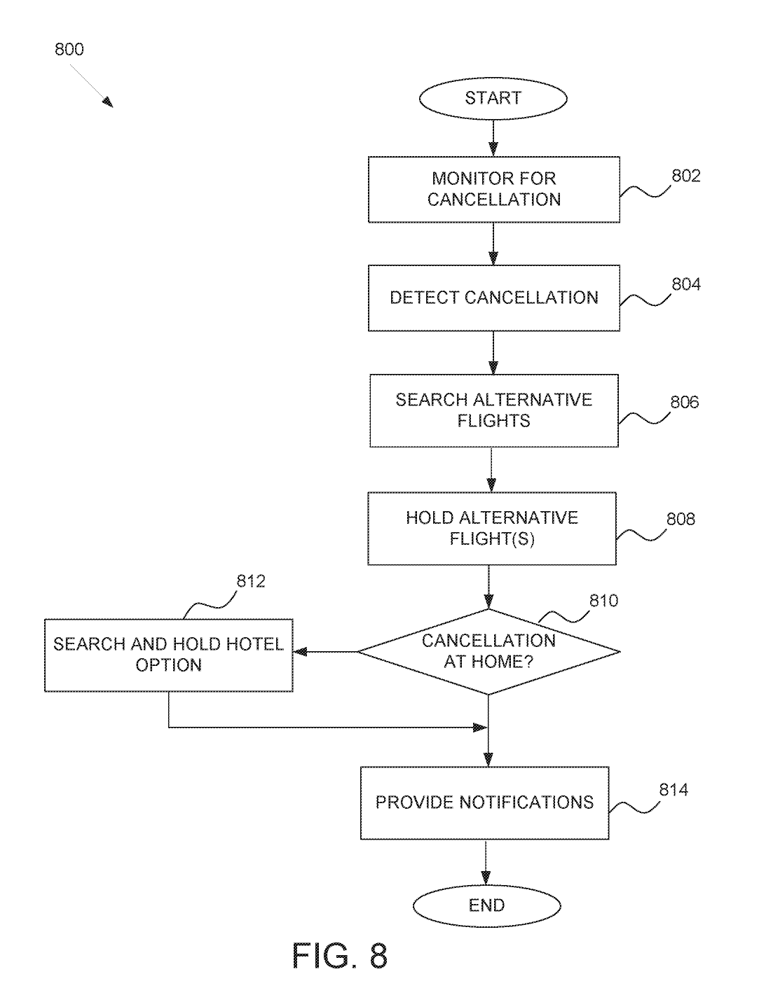

FIG. 8 is a flowchart illustrating operations of the networked travel system 102 in performing a method 800 for automatically taking action on behalf of a user based on a flight cancellation, according to some example embodiments. Accordingly, the method 800 is described by way of example with reference to various components of the networked travel system 102. However, it shall be appreciated that at least some of the operations of the method 800 may be deployed on various other hardware configurations and the method 800 is not intended to be limited to the various components of the networked travel system 102.

In operation 802, the monitoring module 222 monitors for a flight cancellation that affects a booked travel itinerary for the user. For example, the monitoring module 222 may periodically access a third-party airline system (e.g., at the third-party system 108) and determine whether a booked flight is canceled. In other example embodiments, the flight cancellation information may be pushed by the third-party airline system to the networked travel system 102.

If a flight cancellation is detected in operation 804, the monitoring module 222 triggers the search engine 212 to find one or more alternative flight options in operation 806. Accordingly, the search engine 212, in some embodiments, triggers searches to be performed at the third-party systems 108 (e.g., via API calls) to find the alternative flight options. The alternative flight options ideally has characteristics that most closely match the booked flight that is canceled (e.g., destination, date/time of departure or arrival, number of connections) taking into account any preferences of the user (e.g., preferred airline, preferred flight class, least number of connections). A “best” flight option (e.g., next available flight, closest in arrival time) is identified, and the booking module 218 places a hold on the flight option in operation 808 (e.g., generates and transmits instructions to a third-party system 102 to hold the flight option). It is noted that more than one alternative travel option may be held, and the user can select to accept one of the held options. If all flights out of a particular location are canceled or sold out, the networked travel system 102 can default to looking for alternative travel means (e.g., train, rental car, or bus) or alternative travel options (e.g., hotel reservation for the night). Alternatively, if the cancellation makes the entire trip impractical (e.g., same data roundtrip SFO-DEN where weather in Denver prevents takeoffs or landings), the networked travel system 102 determines that no alternative options are possible.

In operation 810, a determination is made as to whether the cancellation is of a flight at a location considered to be a home airport of the user. if the canceled flight is not at the location that is the home airport of the user and the held flight option indicates an extended delay (e.g., the “best” flight option is not until the next day), the search engine 212 also searches for a hotel room (e.g., hotel near the airport where the delay will occur) in operation 812. The booking module 218 also places a hold on the hotel room on behalf of the user. Alternatively, if the canceled flight is at the location that is the home airport, the networked travel system 102 assumes the user will go home during the delay and will not search for a hotel room for the user.

Notifications are provided in operation 814. Accordingly, the response engine 216 transmits a notification to the user indicating the one or more held alternative options (e.g., the held flight option, or the held flight and hotel room options). In some embodiments, the response engine 216 also notifies friends, family, or business contacts regarding the delay or cancellation. For example, the response engine 216 uses a user's calendar integration to proactively inform anyone impacted by the delay or cancellation.

FIG. 9 is a block diagram illustrating components of a machine 900, according to some example embodiments, able to read instructions 924 from a machine-readable medium 922 (e.g., a non-transitory machine-readable medium, a machine-readable storage medium, a computer-readable storage medium, or any suitable combination thereof) and perform any one or more of the methodologies discussed herein, in whole or in part. Specifically, FIG. 9 shows the machine 900 in the example form of a computer device (e.g., a computer) within which the instructions 924 (e.g., software, a program, an application, an applet, an app, or other executable code) for causing the machine 900 to perform any one or more of the methodologies discussed herein may be executed, in whole or in part.

For example the instructions may cause the machine 900 to execute the flow diagrams of FIGS. 5-8. The instructions can transform the general, non-programmed machine into a particular machine (e.g., specially configured machine) programmed to carry out the described and illustrated functions in the manner described

In alternative embodiments, the machine 900 operates as a standalone device or may be connected (e.g., networked) to other machines. The machine 900 may be a server computer, a client computer, a personal computer (PC), a tablet computer, a laptop computer, a netbook, a set-top box (SIB), a personal digital assistant (PDA), a cellular telephone, a smartphone, a web appliance, a network router, a network switch, a network bridge, a power adapter, or any machine capable of executing the instructions 924, sequentially or otherwise, that specify actions to be taken by that machine 900. Further, while only a single machine is illustrated, the term “machine” shall also be taken to include a collection of machines that individually or jointly execute the instructions 924 to perform any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein.

The machine 900 may further include a graphics display 910 (e.g., a plasma display panel (PDP), a light emitting diode (LED) display, a liquid crystal display (LCD), a projector, a cathode ray tube (CRT), or any other display capable of displaying graphics or video). The machine 900 may also include an alphanumeric input device 912 (e.g., a keyboard or keypad), a cursor control device 914 (e.g., a mouse, a touchpad, a trackball, a joystick, a motion sensor, an eye tracking device, or other pointing instrument), a storage unit 916, a signal generation device 918 (e.g., a sound card, an amplifier, a speaker, a headphone jack, or any suitable combination thereof), and a network interface device 920.

The storage unit 916 includes the machine-readable medium 922 (e.g., a tangible machine-readable storage medium) on which are stored the instructions 924 embodying any one or more of the methodologies or functions described herein. The instructions 924 may also reside, completely or at least partially, within the main memory 904, within the processor 902 (e.g., within the processor's cache memory), or both, before or during execution thereof by the machine 900. Accordingly, the main memory 904 and the processor 902 may be considered machine-readable media 922 (e.g., tangible and non-transitory machine-readable media).

In some example embodiments, the machine 900 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and. servers) able to store instructions. The term “machine-readable medium” shall also be taken to include any medium, or combination of multiple media, that is capable of storing instructions for execution by a machine (e.g., machine 900), such that the instructions, when executed by one or more processors of the machine (e.g., processor 902), cause the machine to perform any one or more of the methodologies described herein. The term “machine-readable medium” shall accordingly be taken to include, but not be limited to, one or more data repositories in the form of a solid-state memory, an optical medium, a magnetic medium, or any suitable combination thereof. Therefore, the machine-readable medium may be referred to as a hardware storage device.

Furthermore, the machine-readable medium 922 is non-transitory in that it does not embody a propagating or transitory signal. However, labeling the machine-readable medium 922 as “non-transitory” should not be construed to mean that the medium is incapable of movement—the medium should be considered as being transportable from one physical location to another. Additionally, since the machine-readable medium 922 is tangible, the medium may be considered to be a machine-readable device. Accordingly, the machine-readable medium does not comprise any transitory signals.

The instructions 924 may further be transmitted or received over a communications network 926 using a transmission medium via the network interface device 920 and utilizing any one of a number of well-known transfer protocols (e.g., HTTP). Examples of communication networks include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

The various operations of example methods described herein may be performed, at leas; partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim.

Although an overview of the inventive subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
generating, by a networked travel system, a search query associated with a travel itinerary of a user;
causing, by the networked travel system, a search to be performed using the search query;
detecting, by a hardware processor of the networked travel system, a condition associated with the travel itinerary that triggers automatically holding a travel component on behalf of the user;
automatically triggering, by the networked travel system, placement of a hold on the travel component in response to the detecting of the condition; and
generating and transmitting, over a network by the networked travel system, a notification to a device of the user indicating the automatically held travel component.

2. The method of claim 1, further comprising monitoring an inventory level of the travel component, wherein the detecting the condition comprises detecting that the inventory level of the travel component falls below an inventory low threshold.

3. The method of claim 1, wherein the detecting the condition comprises detecting that the travel component occurs within a shorten time period.

4. The method of claim 1, wherein the condition comprises a delay condition indicating a delay to a component of the travel itinerary, the method further comprising monitoring for the delay condition.

5. The method of claim 4, wherein the delay condition comprises a weather condition that may delay the component of the travel itinerary, wherein the travel component comprises an alternative flight, alternative travel means, or hotel reservation for the travel itinerary.

6. The method of claim 1, wherein the detecting the condition occurs prior to generating the search query for the travel component, the detecting the condition triggering the generating of the search query.

7. The method of claim 1, wherein the condition is a flight cancellation, the method further comprising monitoring for the flight cancellation, and wherein the travel component comprises an alternative flight.

8. The method of claim 7, further comprising:
detecting whether the flight cancellation occurs at a user's home airport; and
based on the determining that the flight cancellation occurs a location not corresponding to the user's home airport, triggering a search for a hotel room near the location; and
automatically triggering placement of a hold on the hotel room near the location.

9. The method of claim 1, further comprising generating and transmitting a notification to inform a contact of the user of a delay condition or a flight cancellation.

10. The method of claim 1, wherein the automatically triggering placement of a hold on the travel component comprises generating and transmitting instructions to a third-party system to hold the travel component on behalf of the user, the instructions causing an update to a database of the third-party system.

11. The method of claim 10, further comprising:
receiving an indication of acceptance of the held travel component from the user; and
generating and transmitting instructions to the third-party system that cause the third-party system to convert the held travel component to a booked travel component.

12. A networked system comprising:
one or more hardware processors; and p1 a hardware storage device comprising instructions that when executed by the one or more hardware processors, cause the one or more hardware processors to perform operations comprising:
generating a search query associated with a travel itinerary of a user;
causing a search to be performed using the search query;
detecting a condition associated with the travel itinerary that triggers automatically holding a travel component on behalf of the user;
automatically triggering placement of a hold on the travel component in response to the detecting of the condition; and
generating and transmitting, over a network, a notification to a device of the user indicating the automatically held travel component.

13. The networked system of claim 12, wherein the operations further comprise monitoring an inventory level of the travel component, wherein the detecting the condition comprises detecting that the inventory level of the travel component falls below an inventory low threshold.

14. The networked system of claim 12, wherein the detecting the condition comprises detecting that the travel component occurs within a shorten time period.

15. The networked system of claim 12, wherein the condition comprises a weather condition that may delay a component of the travel itinerary, wherein the travel component comprises an alternative flight, alternative travel means, or hotel reservation for the travel itinerary.

16. The networked system of claim 12, wherein the detecting the condition occurs prior to generating the search query for the travel component, the detecting e condition triggering the generating of the search query.

17. The networked system of claim 12, wherein the condition is a flight cancellation, the operations further comprising monitoring for the flight cancellation, and wherein the travel component comprises an alternative flight.

18. The networked system of claim 12, wherein the operations further comprise:
receiving an indication of acceptance of the held travel component from the user; and
generating and transmitting instructions to the third-party system that cause the third-party system to convert the held travel component to a booked travel component.

19. A hardware storage device comprising instructions that, when executed by the one or more hardware processors of a machine, cause the machine to perform operations comprising:
generating a search query associated with a travel itinerary of a user;
causing a search to he performed using the search query;
detecting a condition associated with the travel itinerary that triggers automatically holding a travel component on behalf of the user;
automatically triggering placement of a hold on the travel component in response to the detecting of the condition; and
generating and transmitting, over a network, a notification to a device of the user indicating the automatically held travel component.

20. The hardware storage device of claim 19, wherein the operations further comprise:
receiving an indication of acceptance of the held travel component from the user; and
generating and transmitting instructions to the third-party system that cause the third-party system to convert the held travel component to a booked travel component.
